(19) United States
(12) Patent Application Publication
(10) Pub. No.: US 2026/0095952 A1
(43) Pub. Date: Apr. 2, 2026

(54) RACH TRANSMISSION IN A CANDIDATE CELL FOR L1 AND L2 MOBILITY

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 19/110,398

(22) PCT Filed: Nov. 1, 2022
(86) PCT No.: PCT/CN2022/128888

§ 371 Date: Mar. 10, 2025

(51) Int. Cl. H04W 74/0833; H04L 27/26; H04W 72/232

(52) U.S. Cl. CPC H04W 74/0833; H04L 27/26025; H04W 72/232

(57) ABSTRACT

This disclosure provides systems, methods and apparatus, including computer programs encoded on computer storage media for a user equipment (UE) to initiate a layer 1 or layer 2 mobility procedure. The UE receives a configuration of a random access channel (RACH) including RACH occasions for a candidate cell. The UE determines that a condition for a layer 1 or layer 2 mobility procedure to the candidate cell is satisfied. The UE transmits a physical RACH (PRACH) message to the candidate cell to initiate the layer 1 or layer 2 mobility procedure.

### TECHNICAL FIELD

The present disclosure relates to wireless communications including a random access channel (RACH) transmission in a candidate cell for layer 1 and layer 2 mobility.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (such as with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for initiating a L1/L2 mobility procedure. The method includes receiving a configuration of a random access channel (RACH) including RACH occasions for a candidate cell. The method includes determining that a condition for a layer 1 or layer 2 mobility procedure to the candidate cell is satisfied. The method includes transmitting a physical RACH (PRACH) message to the candidate cell to initiate the layer 1 or layer 2 mobility procedure.

The present disclosure also provides an apparatus (e.g., a UE) including a memory storing computer-executable instructions and at least one processor configured to execute the computer-executable instructions to perform at least one of the above methods, an apparatus including means for performing at least one of the above methods, and a non-transitory computer-readable medium storing computer-executable instructions for performing at least one of the above methods.

One innovative aspect of the subject matter described in this disclosure can be implemented in a method of controlling L1/L2 mobility. The method includes transmitting a configuration of a RACH including RACH occasions for a candidate cell. The method includes receiving a PRACH message in the candidate cell to initiate a layer 1 or layer 2 mobility procedure for a UE from an active serving cell to the candidate cell.

The present disclosure also provides an apparatus (e.g., a BS) including a memory storing computer-executable instructions and at least one processor configured to execute the computer-executable instructions to perform at least one of the above methods, an apparatus including means for performing at least one of the above methods, and a non-transitory computer-readable medium storing computer-executable instructions for performing at least one of the above methods.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a diagram illustrating an example of a wireless communications system including an access network.

FIG. 2A is a diagram illustrating an example of a first frame.

FIG. 2B is a diagram illustrating an example of DL channels within a subframe.

FIG. 2C is a diagram illustrating an example of a second frame.

FIG. 2D is a diagram illustrating an example of a subframe.

FIG. 3 is a diagram illustrating an example of a base station (BS) and user equipment (UE) in an access network.

FIG. 4 is a diagram illustrating an example disaggregated base station architecture.

FIG. 5 is a diagram illustrating an example of a layer 1 or layer 2 (L1/L2) mobility scenario.

FIG. 6 is a diagram illustrating transmission of synchronization signal blocks (SSB) for both intra-frequency and inter-frequency mobility.

FIG. 7 is a message diagram 700 illustrating various messages for initiating an L1/L2 mobility procedure.

FIG. 8 is a conceptual data flow diagram illustrating the data flow between different means/components in an example BS.

FIG. 9 is a conceptual data flow diagram illustrating the data flow between different means/components in an example UE.

FIG. 10 is a flowchart of an example of a method for a UE to perform PRACH transmission for L1/L2 mobility.

FIG. 11 is a flowchart of an example method for a network node to support L2/L2 mobility.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless and wired local area network (LAN) communication according to the Institute of Electrical and Electronics Engineers (IEEE) 802.11 wireless standards, the IEEE 802.3 Ethernet standards, and the IEEE 1901 Powerline communication (PLC) standards. However, the described implementations may be implemented in any device, system or network that is capable of transmitting and receiving RF signals according to any of the wireless communication standards, including any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G or 5G, or further implementations thereof, technology.

Conventionally, in a wireless communications network such as a 5G NR network, mobility procedures are performed at layer 3 (L3) using radio resource control (RRC) messaging. Mobility procedures allow a user equipment (UE) to move from a source cell to a target cell. In some scenarios, L3 mobility procedures may involve an interruption or gap in communications as the UE establishes an RRC connection with the target cell. Mobility procedures at layer 1 or layer 2 (L1/L2) offer the possibility of improving the speed of mobility over L3 mobility procedures. L1 and L2, however, offer less flexibility in terms of types and content of messages that may be transmitted.

In an aspect, the present disclosure provides for random access channel (RACH) transmission in a candidate cell for L1/L2 mobility. A PRACH transmission from the UE in a candidate cell may provide the candidate cell with uplink information about the UE that may be used to initiate a L1/L2 mobility procedure. The UE may identify candidate cells (both intra-frequency and inter-frequency) and RACH opportunities of the candidate cells for transmission of the PRACH. For example, the UE may receive a configuration of a RACH for the candidate cell as a synchronization signal block (SSB), which may be transmitted by an active serving cell or a candidate cell depending on whether the candidate cell is an intra-frequency cell or an inter-frequency cell. The UE may determine when a L1/L2 mobility condition is satisfied. For example, the condition may be evaluated by the UE based on a rule, or the UE may receive a trigger signal indicating that the condition is satisfied. In response to the condition being satisfied, the UE may transmit a physical RACH (PRACH) message on an appropriate RACH occasion of the candidate cell to initiate the L1/L2 mobility procedure.

Particular implementations of the subject matter described in this disclosure can be implemented to realize one or more of the following potential advantages. L1/L2 mobility procedures may improve the latency of mobility, thereby reducing interruption in communications during mobility. The use of a PRACH to initiate the L1/L2 mobility procedure may provide flexibility in various scenarios such as mobility to intra-frequency and inter-frequency candidate cells. L1/L2 mobility may use less signaling overhead than other mobility procedures.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. The processor may include an interface or be coupled to an interface that can obtain or output signals. The processor may obtain signals via the interface and output signals via the interface. In some implementations, the interface may be a printed circuit board (PCB) transmission line. In some other implementations, the interface may include a wireless transmitter, a wireless transceiver, or a combination thereof. For example, the interface may include a radio frequency (RF) transceiver which can be implemented to receive or transmit signals, or both. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media, which may be referred to as non-transitory computer-readable media. Non-transitory computer-readable media may exclude transitory signals. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

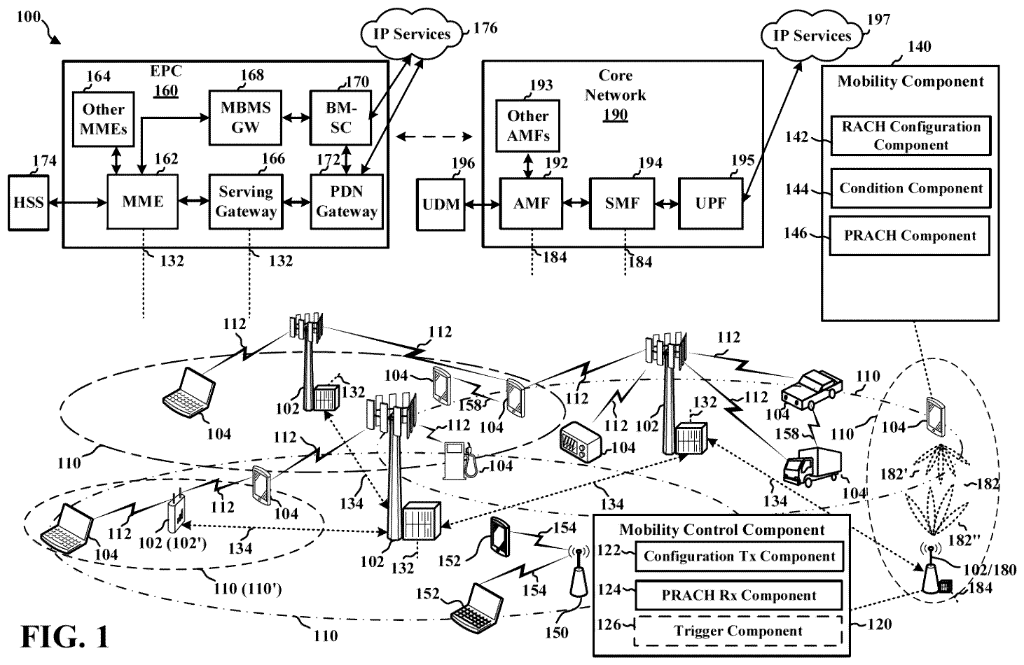

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (such as a 5G Core (5GC)). The base stations 102 may include macrocells (high power cellular base station) or small cells (low power cellular base station). The macrocells include base stations. The small cells include femtocells, picocells, and microcells. The small cells include femtocells, picocells, and microcells. The base stations 102 can be configured in a Disaggregated RAN (D-RAN) or Open RAN (O-RAN) architecture, where functionality is split between multiple units such as a central unit (CU), one or more distributed units (DUs), or a radio unit (RU). Such architectures may be configured to utilize a protocol stack that is logically split between one or more units (such as one or more CUs and one or more DUs). The base stations 102 may be referred to as network nodes or network entities. In some aspects, the CUS may be implemented within an edge RAN node, and in some aspects, one or more DUs may be co-located with a CU, or may be geographically distributed throughout one or multiple RAN nodes. The DUs may be implemented to communicate with one or more RUs.

In some implementations, one or more of the UEs 104 may include a mobility component 140 that performs a L1/L2 mobility procedure. The mobility component 140 may include a RACH configuration component 142 configured to receive a configuration of a random access channel (RACH) including RACH occasions for a candidate cell. The mobility component 140 may include a condition component 144 configured to determine that a condition for a layer 1 or layer 2 mobility procedure to the candidate cell is satisfied. The mobility component 140 may include PRACH component 146 configured to transmit a physical RACH (PRACH) message to the candidate cell to initiate the layer 1 or layer 2 mobility procedure.

In some implementations, one or more of the base stations 102 (or network nodes) may include a mobility control component 120 configured to manage a L1/L2 mobility procedure for a UE. The mobility control component 120 may include a configuration Tx component 122 configured to transmit a configuration of a random access channel (RACH) including RACH occasions for a candidate cell. The mobility control component 120 may include a PRACH Rx component 124 configured to receive a PRACH message in the candidate cell to initiate a layer 1 or layer 2 mobility procedure for a UE. In some implementations, the mobility control component 120 may optionally include a trigger component 126 configured to transmit a triggering signal from the active serving cell that triggers the UE to transmit the PRACH message.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (such as S1 interface), which may be wired or wireless. The base stations 102 configured for 5G NR (collectively referred to as Next Generation RAN (NG-RAN)) may interface with core network 190 through second backhaul links 184, which may be wired or wireless. In addition to other functions, the base stations 102 may perform one or more of the following functions: transfer of user data, radio channel ciphering and deciphering, integrity protection, header compression, mobility control functions (such as handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (such as through the EPC 160 or core network 190) with each other over third backhaul links 134 (such as X2 interface). The third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network also may include Home Evolved Node Bs (eNBs) (HeNBs), which may provide service to a restricted group known as a closed subscriber group (CSG). The communication links 112 between the base stations 102 and the UEs 104 may include UL (also referred to as reverse link) transmissions from a UE 104 to a base station 102 or DL (also referred to as forward link) transmissions from a base station 102 to a UE 104. The communication links 112 may use multiple-input and multiple-output (MIMO) antenna technology, including spatial multiplexing, beamforming, or transmit diversity. The communication links may be through one or more carriers. The base stations 102/UEs 104 may use spectrum up to Y MHz (such as 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (such as more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to or increase capacity of the access network.

A base station 102, whether a small cell 102′ or a large cell (such as macro base station), may include an eNB, gNodeB (gNB), or other type of base station. Some base stations, such as gNB 180 may operate in one or more frequency bands within the electromagnetic spectrum.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” (mmW) band in documents and articles, despite being different from the extremely high frequency (EHF) band (30 GHz-300 GHZ) which is identified by the International Telecommunications Union (ITU) as a “millimeter wave”band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Communications using the mmW radio frequency band have extremely high path loss and a short range. The mmW base station 180 may utilize beamforming 182 with the UE 104 to compensate for the path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, or other IP services.

The base station may include or be referred to as a gNB, Node B, eNB, network node, network entity, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (such as a MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (such as a parking meter, gas pump, toaster, vehicles, heart monitor, etc.). The UE 104 also may be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the following description may be focused on 5G NR, the concepts described herein may be applicable to other similar areas, such as LTE, LTE-A, CDMA, GSM, and other wireless technologies including future 6G technologies.

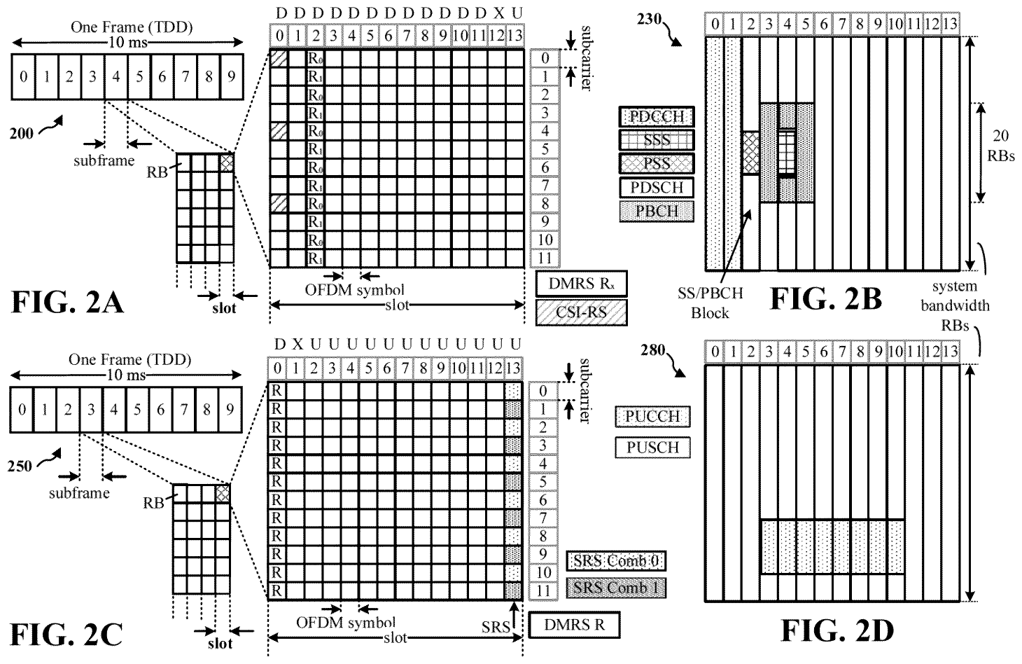

FIG. 2A is a diagram 200 illustrating an example of a first frame. FIG. 2B is a diagram 230 illustrating an example of DL channels within a subframe. FIG. 2C is a diagram 250 illustrating an example of a second frame. FIG. 2D is a diagram 280 illustrating an example of a subframe. The 5G NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. A subset of the total cell bandwidth of a cell is referred to as a Bandwidth Part (BWP) and bandwidth adaptation is achieved by configuring the UE with BWP(s) and telling the UE which of the configured BWPs is currently the active one. In an aspect, a narrow bandwidth part (NBWP) refers to a BWP having a bandwidth less than or equal to a maximum configurable bandwidth of a BWP. The bandwidth of the NBWP is less than the carrier system bandwidth.

In the examples provided by FIGS. 2A, 2C, the 5G NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure or different channels. A frame (10 milliseconds (ms)) may be divided into 10 equally sized subframes (1 ms). Each subframe may include one or more time slots. Subframes also may include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100× is the port number, but other DM-RS configurations are possible) and channel state information reference signals (CSI-RS) for channel estimation at the UE. The RS also may include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a L1 identity. A secondary synchronization signal (SSS) may be within symbol 4 of particular subframes of a frame. The SSS is used by a UE to determine a L1 cell identity group number and radio frame timing. Based on the L1 identity and the L1 cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), or UCI.

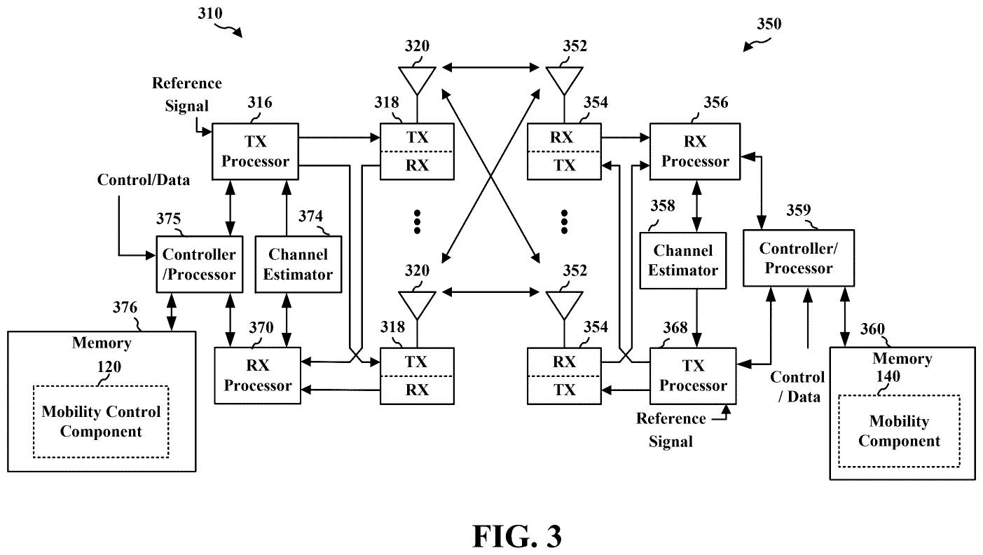

FIG. 3 is a diagram of an example of a base station 310 and a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (such as MIB, SIBs), RRC connection control (such as RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (such as binary phase-shift keying (BPSK), quadrature phase-shift keying (QPSK), M-phase-shift keying (M-PSK), M-quadrature amplitude modulation (M-QAM)). The coded and modulated symbols may be split into parallel streams. Each stream may be mapped to an OFDM subcarrier, multiplexed with a reference signal (such as a pilot) in the time or frequency domain, and combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal or channel condition feedback transmitted by the UE 350. Each spatial stream may be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are decoded and deinterleaved to recover the data and control signals that were originally transmitted by the base station 310 on the physical channel. The data and control signals are provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK or NACK protocol to support HARQ operations.

Similar to the functionality described in connection with the DL transmission by the base station 310, the controller/processor 359 provides RRC layer functionality associated with system information (such as MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK or NACK protocol to support HARQ operations.

At least one of the TX processor 368, the RX processor 356, and the controller/processor 359 may be configured to perform aspects in connection with the mobility component 140 of FIG. 1. For example, the memory 360 may include executable instructions defining the mobility component 140. The TX processor 368, the RX processor 356, and/or the controller/processor 359 may be configured to execute the mobility component 140.

At least one of the TX processor 316, the RX processor 370, and the controller/processor 375 may be configured to perform aspects in connection with the mobility control component 120 of FIG. 1. For example, the memory 376 may include executable instructions defining the mobility control component 120. The TX processor 316, the RX processor 370, and/or the controller/processor 375 may be configured to execute the mobility control component 120.

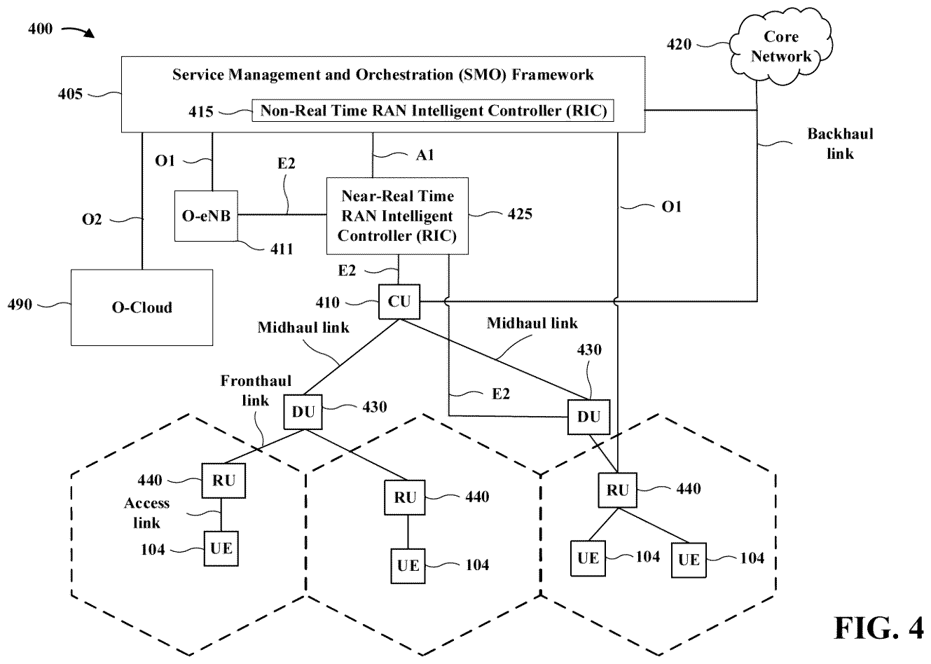

FIG. 4 is a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated base station units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DUs) 430 via respective midhaul links, such as an F1 interface. The DUs 430 may communicate with one or more radio units (RUs) 440 via respective fronthaul links. The RUs 440 may communicate with respective UEs 104 via one or more radio frequency (RF) access links. In some implementations, the UE 104 may be simultaneously served by multiple RUs 440.

Each of the units, i.e., the CUS 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the El interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 104. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an Ol interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUS 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an Al interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

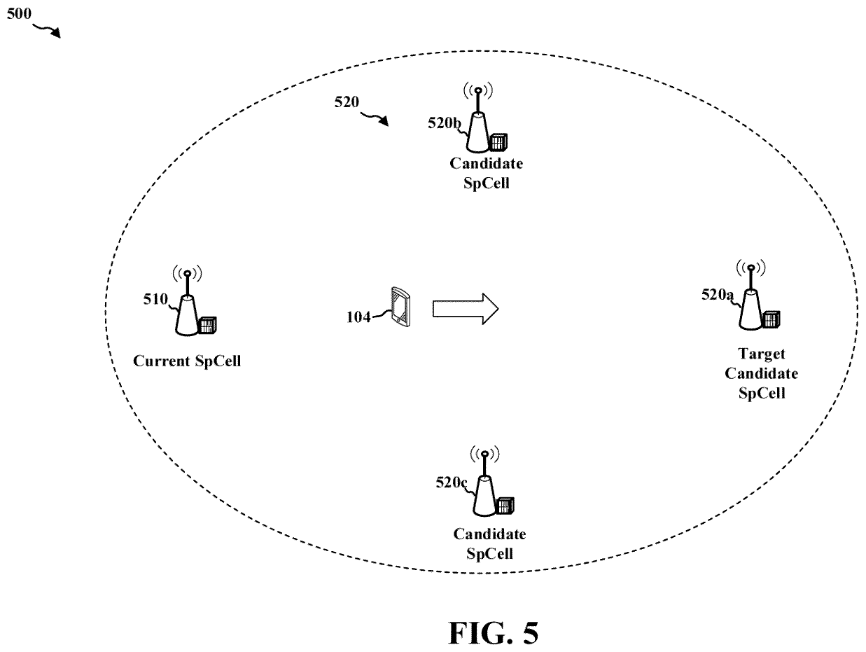

FIG. 5 is a diagram illustrating an example of a L1/L2 mobility scenario 500. A UE 104 may initially be served by an active serving cell 510, which may be referred to as a special cell (SpCell). L1/L2 mobility may allow the SpCell to be updated via L1/L2 signaling based on L1 measurements. The scenario 500 may apply to a single SpCell change without carrier aggregation (CA). L1/L2 mobility may apply to both intra-frequency mobility and inter-frequency mobility.

During a L1/L2 mobility procedure, the UE 104 may determine a target candidate cell 520a from a set of candidate cells 520. For example, the set of candidate cells 520 may include candidate cells 520a, 520b, and 520c. The target candidate cell 520a may be selected based on, for example, L1 measurement.

L1/L2 mobility may include mechanisms and procedures of L1/L2 based inter-cell mobility for mobility latency reduction. For example, configuration and maintenance for multiple candidate cells may allow fast application of configurations for candidate cells 520. A dynamic switch mechanism among candidate serving cells (including SpCells and secondary cells (SCells)) may satisfy multiple potential applicable scenarios based on L1/L2 signaling. L1 enhancements for inter-cell beam management, including L1 measurement and reporting, and beam indication may facilitate L1/L2 mobility. Timing Advance management for candidate cells may facilitate L1/L2 mobility. CU-DU interface signaling to support L1/L2 mobility may be applicable in a distributed architecture. Example L1/L2 mobility scenarios include: Standalone, CA and NR-DC cases with serving cell change within one cell group (CG); Intra-DU case and intra-CU inter-DU case (applicable for Standalone and CA); both intra-frequency and inter-frequency mobility; both FR1 and FR2 frequency ranges; and when source and target cells are synchronized or non-synchronized.

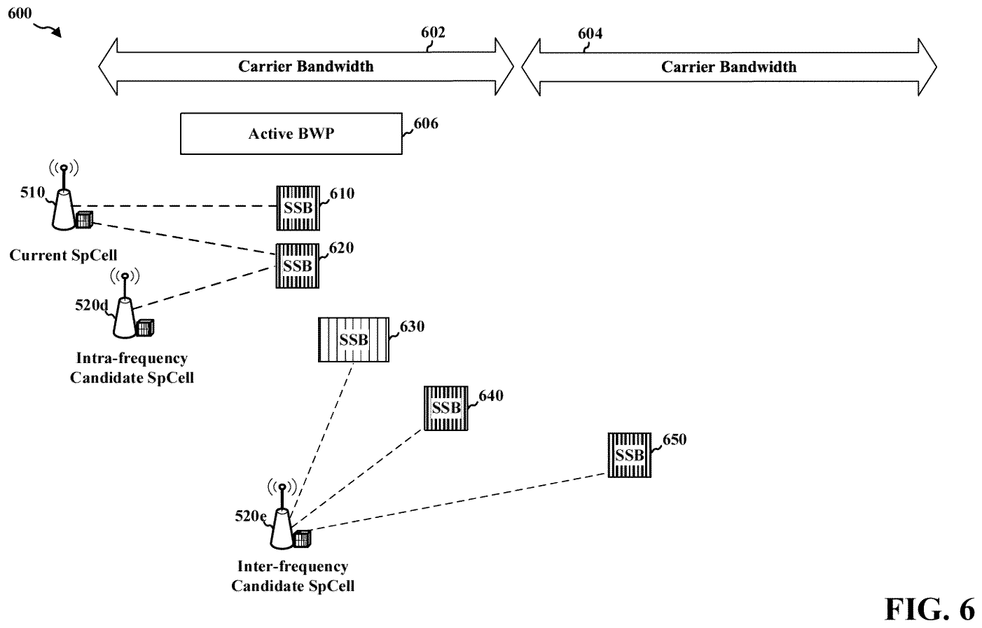

FIG. 6 is a diagram 600 illustrating transmission of synchronization signal blocks (SSB) for both intra-frequency and inter-frequency mobility. The active serving cell 510 may transmit an SSB 610 on a center frequency within a configured active bandwidth part (BWP) 606 within a carrier bandwidth 602. An intra-frequency candidate cell 520d may be a candidate cell that operates on the same carrier bandwidth 602, active BWP 606, center frequency, and has the same subcarrier spacing (SCS) as the active serving cell 510. In some implementations, the active serving cell 510 may transmit an SSB 620 that is associated with a physical cell identifier (PCI) of the intra-frequency candidate cell 520d. For instance, the intra-frequency candidate cell 520d may be inactive until selected for mobility. In some implementations, the intra-frequency candidate cell 520d may transmit the SSB 620 on the center frequency within active BWP 606 on carrier bandwidth 602. An inter-frequency candidate cell 520e may be a candidate SpCell that differs in center frequency, SCS, active BWP, or carrier bandwidth 602 from the active serving cell 510. For instance, the inter-frequency candidate cell 520e may transmit an SSB 630 within an active BWP 606 of the active serving cell 510 but with a center frequency or SCS that is different than the SSB 610 of the active serving cell 510. As another example, the inter-frequency candidate cell 520e may transmit an SSB 640 outside of the active BWP 606 of the active serving cell 510 but within the configured carrier bandwidth 602 of the active serving cell 510. As another example, the inter-frequency candidate cell 520e may transmit an SSB 650 outside of the configured carrier bandwidth 602 of the active serving cell 510 (e.g., in a carrier bandwidth 604).

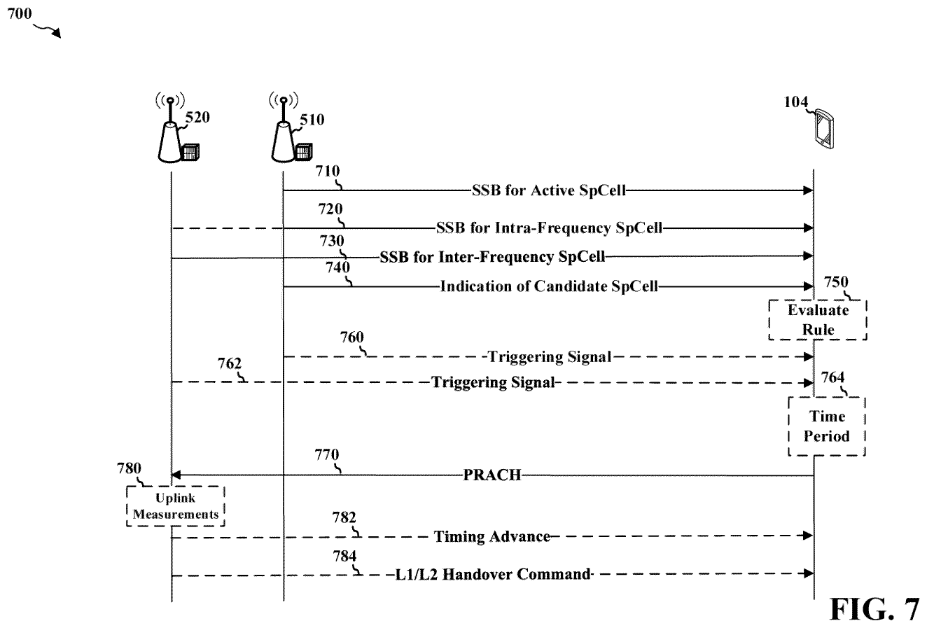

FIG. 7 is a message diagram 700 illustrating various messages for initiating an L1/L2 mobility procedure.

In an aspect, the active serving cell 510 may transmit an SSB 710, which may correspond to the SSB 610. The SSB 710 may provide information about the active serving cell 510 and may be used by the UE 104 to measure signal quality (e.g., L1 RSRP) of the active serving cell 510. The active serving cell 510 and/or the candidate SpCell 520 may transmit an SSB 720, which may correspond to the SSB 620. SSB 720 may be associated with a PCI of the candidate cell 520 (e.g., intra-frequency cell 520d). The SSB 720 may be included in a configuration of a RACH for the candidate cell 520. For example, the SSB 720 may identify or may be associated with RACH occasions on which the UE 104 may transmit a PRACH message based on the SSB 720. The UE 104 may also measure signal quality of the candidate cell 520 based on the SSB 720. The candidate cell 520 may transmit an SSB 730, which may correspond to any of the SSBs 630, 640, or 650. SSB 730 may be associated with a PCI of the candidate cell 520 (e.g., inter-frequency candidate cell 520e). The SSB 730 may include a configuration of a RACH for the candidate cell 520. For example, the SSB 730 may identify RACH occasions on which the UE 104 may transmit a PRACH message based on the SSB 730. The UE 104 may also measure signal quality of the candidate cell 520 based on the SSB 730. In some implementations, the UE 104 may be configured with L1 measurement gaps to measure the SSB 730.

In some implementations, the active serving cell 510 may transmit an indication 740 of candidate cells. For example, the indication 740 of candidate cells may be an RRC configuration message, MAC-CE, or DCI that configures the UE 104 with one or more candidate cells 520. For instance, indication 740 of candidate cells may include one or more PCIs and/or frequencies of the candidate cells 520. The UE 104 may receive the appropriate SSBs 720, 730 to obtain the RACH configuration and measurements for the configured or indicated candidate cells 520.

In some implementations, at block 750, the UE 104 may determine that a condition for a layer 1 or layer 2 mobility procedure to a candidate cell is satisfied by evaluating a rule to select the candidate cell. For example, the rule may be specified in a standards document or regulation and/or configured by the active serving cell 510. For example, the active serving cell 510 may provide an RRC configuration message with parameters for the rule. In some implementations, the rule indicates the candidate cell when a cell-level or beam-level measurement for the candidate cell is greater than a threshold for the candidate cell. In some implementations, the rule indicates the candidate cell when a cell-level or beam-level measurement for the candidate cell has changed by at least a threshold amount for the candidate cell. In some implementations, the rule is based on a timing advance misalignment timer for a candidate cell. For example, the UE 104 may determine that the condition for the layer 1 or layer 2 mobility procedure to the candidate cell is satisfied by determining that a timing advance misalignment timer has expired for the candidate cell (e.g., the timing may be out of synch).

In some implementations, the active serving cell 510 and/or the candidate cell 520 may transmit a triggering signal 760, 762 that triggers transmitting a PRACH message. For example, the triggering signal 760 may be a downlink control information (DCI) from the active serving cell 510 including a physical downlink control channel (PDCCH) order for the PRACH on the candidate cell 520. As another example, the triggering signal 762 may be a DCI from the candidate cell 520 including a PDCCH order for the PRACH message on the candidate cell 520. In another example, the triggering signal 760 may be a media access control (MAC) control element (CE) transmitted by the active serving cell 510. When the triggering signal 760 is a MAC-CE, the UE 104 may wait for a time period 764 from the MAC-CE or an acknowledgment of the MAC-CE before transmitting the PRACH message 770. In some implementations, the triggering signal 760 is a radio resource control (RRC) configuration or reconfiguration of the candidate cell 520.

In some implementations, the triggering signal 760, 762 indicates a single SSB for the PRACH message 770. The UE 104 may transmit the PRACH message 770 based on the single SSB. In some implementations, the triggering signal indicates multiple SSBs for the PRACH message 770. The UE 104 may select one SSB of the multiple SSBs for the PRACH message 770. In some implementations, the triggering signal does not indicate an SSB for the PRACH message. The UE 104 may select any received SSB of the candidate cell for the PRACH message 770.

The PRACH message 770 may allow the candidate cell 520 to obtain uplink information about the UE 104. For example, at block 780. the candidate cell 520 may perform uplink measurements. For instance, the candidate cell 520 may determine an uplink timing and an uplink transmission power. In some implementations, an L1/L2 mobility procedure may include transmitting a timing advance 782 from the candidate cell 520 to the UE 104. In some implementations, the L1/L2 mobility procedure may include an L1/L2 handover command from either the candidate cell 520 or the active serving cell 510.

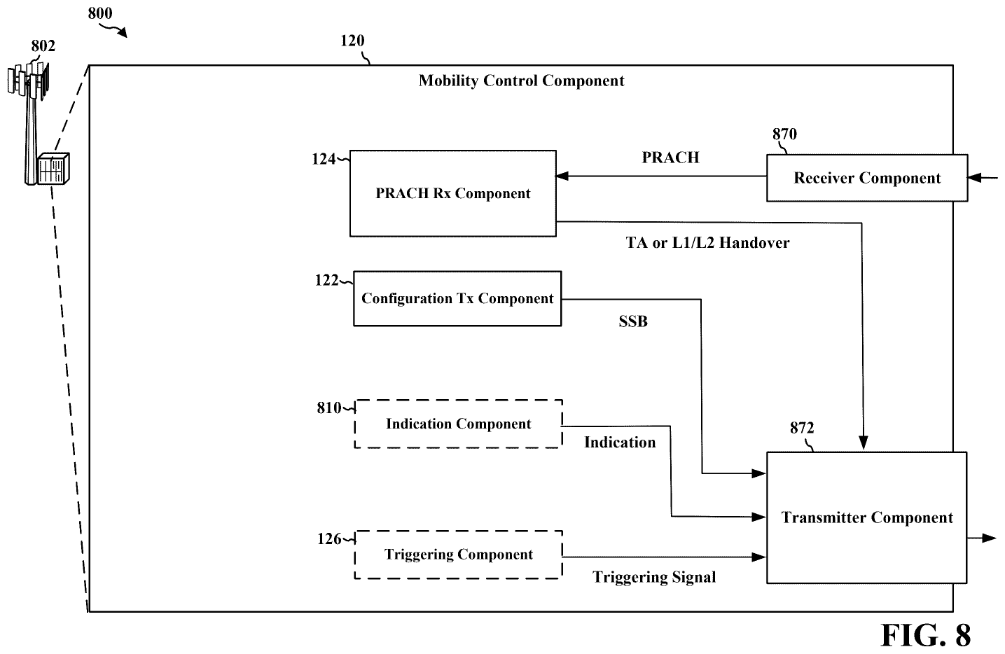

FIG. 8 is a conceptual data flow diagram 800 illustrating the data flow between different means/components in an example base station 802 (e.g., a network node), which may be an example of the base station 102 including the mobility control component 120. The mobility control component 120 may be implemented by the memory 376 and the TX processor 316, the RX processor 370, and/or the controller/processor 375 of FIG. 3. For example, the memory 376 may store executable instructions defining the mobility control component 120 and the TX processor 316, the RX processor 370, and/or the controller/processor 375 may execute the instructions.

The base station 102 may include a receiver component 870, which may include, for example, a radio frequency (RF) receiver for receiving the signals described herein. The base station 102 may include a transmitter component 872, which may include, for example, an RF transmitter for transmitting the signals described herein. In an aspect, the receiver component 870 and the transmitter component 872 may co-located in a transceiver such as illustrated by the TX/RX 318 in FIG. 3.

As discussed with respect to FIG. 1, the mobility control component 120 may include the configuration Tx component 12 and the active PRACH Rx component 124. The mobility control component 120 may optionally include the trigger component 126 or an indication component 810.

The receiver component 870 may receive UL signals from the UE 104 including UL communications. In some implementations, the receiver component 870 may optionally receive the PRACH message 770. The receiver component 870 may provide the PRACH message to the PRACH Rx component 124.

The configuration Tx component 122 may be configured to transmit a configuration of a RACH including RACH occasions for a candidate cell. For example, the configuration Tx component 122 may transmit any of the SSBs 710, 720, or 730, depending on the configuration of a cell supported by the base station 802 and/or the migration control component 120. The configuration Tx component 122 may generate a primary synchronization signal (PSS) and secondary synchronization signal (SSS) associated with a PCI of the candidate cell. The configuration Tx component 122 may generate a broadcast channel (BCH) and/or system information including cell access parameters. For example, the configuration Tx component 122 may generate a RACH configuration that defines RACH occasions for a UE to transmit a PRACH. The configuration Tx component 122 may output the SSB including PSS, SSS, and BCH for transmission via the transmitter component 872.

The optional indication component 810 may be configured to transmit an indication from the active serving cell that indicates transmission of the PRACH message for the candidate cell. The indication component 810 may obtain information of candidate cells via a backhaul. The indication component 810 may receive information regarding the UE such as uplink channel state information and measurements via the receiver component 870. The indication component 810 may generate an indication 740 of one or more candidate cells for the UE. For example, the indication may include a PCI and/or frequency for each candidate cell. The indication component 810 may output the indication 740 for transmission via the transmitter component 872.

The optional trigger component 126 may be configured to transmit a triggering signal from the active serving cell that triggers the UE to transmit the PRACH message. The trigger component 126 may be configured to evaluate various conditions for mobility of the UE. For example, the conditions may be based on reported channel measurements such as L1 RSRP. The trigger component 126 may transmit the triggering signal in response to determining that a mobility condition is satisfied. The trigger signal may have various forms such as an RRC configuration, MAC-CE, or DCI including a PDCCH order. The trigger component 126 may output the trigger signal for transmission via the transmitter component 872.

The PRACH Rx component 124 may be configured to receive a PRACH message 770 in the candidate cell to initiate a layer 1 or layer 2 mobility procedure for a UE from an active serving cell to the candidate cell. For example, the PRACH Rx component 124 may obtain the PRACH message 770 via the receiver component 870. The PRACH Rx component 124 may identify a PRACH preamble of the PRACH message 770. The PRACH Rx component 124 may measure various uplink properties of the UE 104 such as an uplink timing and uplink transmit power based on the PRACH message 770. In some implementations, the PRACH Rx component 124 may initiate the L1/L2 mobility procedure by transmitting an L1/L2 message such as a timing advance 782 or L1/L2 handover command 784.

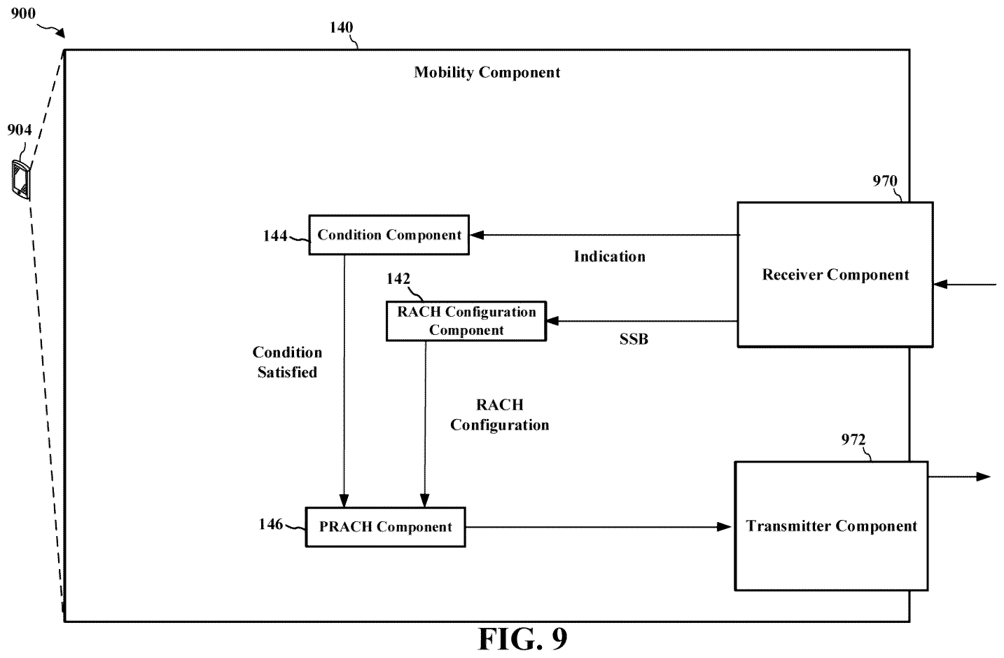

FIG. 9 is a conceptual data flow diagram 900 illustrating the data flow between different means/components in an example UE 904, which may be an example of the UE 104 and include the mobility component 140. The mobility component 140 may be implemented by the memory 360 and the TX processor 368, the RX processor 356, and/or the controller/processor 359. For example, the memory 360 may store executable instructions defining the mobility component 140 and the TX processor 368, the RX processor 356, and/or the controller/processor 359 may execute the instructions.

The UE 104 may include a receiver component 970, which may include, for example, a RF receiver for receiving the signals described herein. The UE 104 may include a transmitter component 972, which may include, for example, an RF transmitter for transmitting the signals described herein. In an aspect, the receiver component 970 and the transmitter component 972 may co-located in a transceiver such as the TX/RX 352 in FIG. 3.

As discussed with respect to FIG. 1, the mobility component 140 may include the RACH configuration component 142, the condition component 144, and the PRACH component 146

The receiver component 970 may receive DL signals described herein such as the SSBs 710, 720, or 730, the indication 740, the triggering signal 760 or 762, the timing advance 782, or the L1/L2 handover command 784. The receiver component 970 may provide the SSBs 710, 720, or 730 to the RACH configuration component 142. The receiver component 970 provide the indication 740 and/or the triggering signals 760, 762 to the condition component 144. The receiver component 970 may provide the timing advance 782 or the L1/L2 handover command 784 to the mobility component 140.

The RACH configuration component 142 may be configured to receive a configuration of a RACH including RACH occasions for a candidate cell. For example, the RACH configuration component 142 may receive SSBs 710, 720, 730 via the receiver component 970. The RACH configuration component 142 may decode the SSBs 710, 720, 730 to determine the PCI of each candidate cell. The RACH configuration component 142 may decode the BCH portion of the SSBs 710, 720, 730 to determine the RACH configuration of each candidate cell. The RACH configuration component 142 may output the RACH occasions to the PRACH component 146.

The condition component 144 may be configured to determine that a condition for a layer 1 or layer 2 mobility procedure to the candidate cell is satisfied. In some implementations, the condition component 144 may receive the indication 740 via the receiver component 970. The condition component 144 may decode the indication to determine the candidate cells.

In some implementations, the condition component 144 may determine that a condition for a layer 1 or layer 2 mobility procedure to the candidate cell is satisfied by evaluating a rule to select a candidate cell. For example, the rule may indicate the candidate cell when a cell-level or beam-level measurement for the candidate cell is greater than a threshold for the candidate cell. The condition component 144 may obtain measurements via the receiver component 970, for example, a L1 RSRP based on the SSBs 710, 720, 730. The condition component 144 may compare the cell-level or beam-level measurement to the threshold. In some implementations, the rule indicates the candidate cell when a cell-level or beam-level measurement for the candidate cell has changed by at least a threshold amount for the candidate cell. The condition component 144 may determine the change of the cell-level or beam-level measurement and compare to the threshold.

In some implementations, the condition component 144 may determine that the condition for the layer 1 or layer 2 mobility procedure to the candidate cell is satisfied when a timing advance misalignment timer has expired for the candidate cell. The condition component 144 may maintain a timing advance misalignment timer for each candidate cell. The condition component 144 may reset the respective timer whenever the UE receives the timing advance 782 from the respective candidate cell. The condition component 144 may identify a candidate cell when the timing advance misalignment timer expires.

In some implementations, the condition component 144 may receive a triggering signal from an active serving cell that triggers transmitting the PRACH message. The condition component 144 may determine that the condition is satisfied upon receiving the triggering signal 760, 762. For example, the triggering signal 760, 762 may be an RRC configuration or reconfiguration of a candidate cell, a MAC-CE, or a DCI including a PDCCH order. When the triggering signal 760, 762 is a MAC-CE the condition component 144 may determine the time period 764 to wait after the MAC-CE or acknowledgement thereof before transmitting the PRACH. In some implementations, the triggering signal may indicate zero or more SSBs for the PRACH. The condition component 144 may decode the triggering signal to indicate whether the triggering signal indicates an SSB. The condition component 144 may output an indication that the condition has been satisfied to the PRACH component 146. In some implementations, the condition component 144 may output an indication of an SSB to the PRACH component 146.

The PRACH component 146 may be configured to transmit a PRACH message to the candidate cell to initiate the layer 1 or layer 2 mobility procedure. The PRACH component 146 may obtain PRACH occasions for the candidate cell from the RACH configuration component 142. The PRACH component 146 may receive the indication that the condition is satisfied from the condition component 144. In some implementations, the PRACH component 146 may receive an indication of an SSB to use for the PRACH message 770. In other implementations, the PRACH component 146 may select the SSB (e.g., based on measurements). The PRACH component 146 may select a RACH occasion and preamble for transmission (e.g., based on the SSB). The PRACH component 146 may output the PRACH message 770 for transmission via the transmitter component 972.

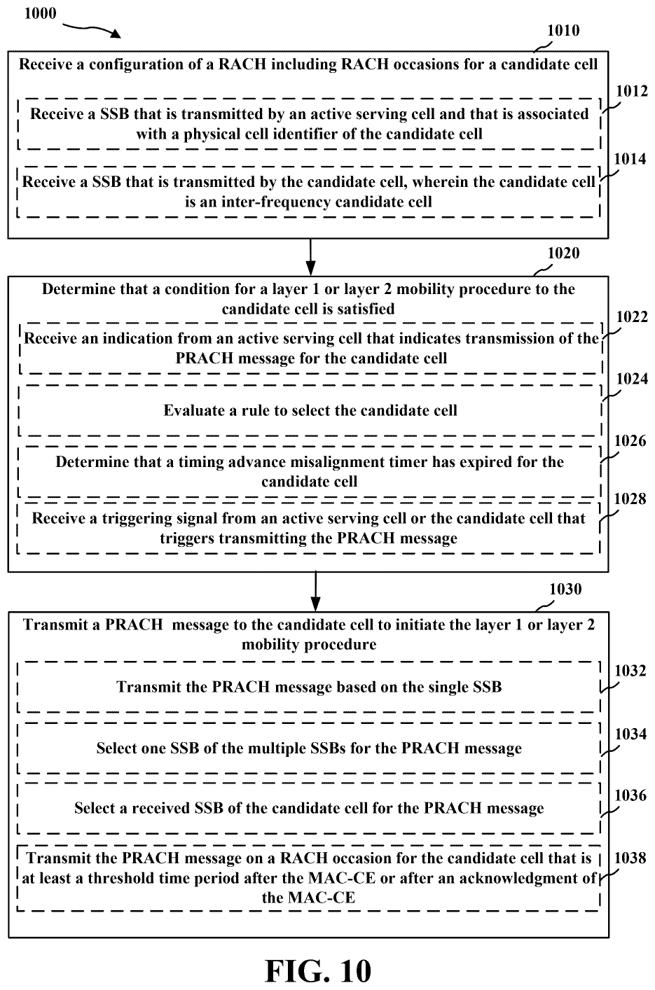

FIG. 10 is a flowchart of an example method 1000 for a UE to initiate a L1/L2 mobility procedure. The method 1000 may be performed by a UE (such as the UE 104, which may include the memory 360 and which may be the entire UE 104 or a component of the UE 104 such as the mobility component 140, TX processor 368, the RX processor 356, or the controller/processor 359). The method 1000 may be performed by the mobility component 140 in communication with the mobility control component 120 of the base station 102. Optional blocks are shown with dashed lines.

At block 1010, the method 1000 may include receiving a configuration of a RACH including RACH occasions for a candidate cell. In some implementations, for example, the UE 104, the RX processor 356 or the controller/processor 359 may execute the mobility component 140 or the RACH configuration component 142 to receive configuration of the RACH (e.g., SSB 710, 720, 730) including RACH occasions for a candidate cell 520. In some implementations, at sub-block 1012, the block 1010 may optionally include receiving a SSB 720 that is transmitted by an active serving cell 510 and that is associated with a physical cell identifier of the candidate cell 520. The candidate cell may be an intra-frequency candidate cell 520d that has a same frequency, sub-carrier spacing, and bandwidth part as the active serving cell 510. In some implementations, at sub-block 1014, the block 1010 may optionally include receiving a SSB 730 that is transmitted by the candidate cell 520. The candidate cell 520 may be an inter-frequency candidate cell 520e. The inter-frequency candidate cell 520e may transmit the SSB 650 outside of a configured bandwidth 602 of an active serving cell 510. The inter-frequency candidate cell 520e may transmit the SSB 640 outside of an active bandwidth part 606 of an active serving cell 510 but within a configured bandwidth 602 of the active serving cell 510. The inter-frequency candidate cell 520e may transmit the SSB 630 within an active bandwidth part 606 of an active serving cell but with a center frequency or sub-carrier spacing that is different than an SSB 610 of the active serving cell 510. Accordingly, the UE 104, the RX processor 356, or the controller/processor 359 executing the mobility component 140 or the RACH configuration component 142 may provide means for receiving a configuration of a RACH including RACH occasions for a candidate cell.

At block 1020, the method 1000 may include determining that a condition for a layer 1 or layer 2 mobility procedure to the candidate cell is satisfied. In some implementations, for example, the UE 104, the RX processor 356 or the controller/processor 359 may execute the mobility component 140 or the condition component 144 to determine that a condition for a layer 1 or layer 2 mobility procedure to the candidate cell is satisfied. In some implementations, at sub-block 1022, the block 1020 may optionally include receiving an indication 740 from an active serving cell 510 that indicates transmission of the PRACH message 770 for the candidate cell 520. In some implementations, at sub-block 1024, the block 1020 may optionally include evaluating a rule to select the candidate cell 520. For example, the rule may indicate the candidate cell 520 when a cell-level or beam-level measurement for the candidate cell is greater than a threshold for the candidate cell. As another example, the rule may indicate the candidate cell when a cell-level or beam-level measurement for the candidate cell has changed by at least a threshold amount for the candidate cell. In some implementations, at sub-block 1026, the block 1020 may optionally include determining that a timing advance misalignment timer has expired for the candidate cell 520. In some implementations, at sub-block 1028, the block 1020 may optionally include receiving a triggering signal 760 from an active serving cell 510 or the candidate cell 520 that triggers transmitting the PRACH message. For example, the triggering signal may be a DCI from the active serving cell 510 including a PDCCH order for the PRACH message 770 on the candidate cell 520. As another example, the triggering signal may be a DCI from the candidate cell including a PDCCH order for the PRACH message 770 on the candidate cell 520. As yet another example, the triggering signal may be MAC-CE transmitted by the active serving cell 510. As yet another example, the triggering signal may be a RRC configuration or reconfiguration of the candidate cell 520. In some implementations, the triggering signal indicates a single SSB, multiple SSBs, or no SSBs for the PRACH message 770. Accordingly, the UE 104, the RX processor 356, or the controller/processor 359 executing the mobility component 140 or condition component 144 may provide means for determining that a condition for a layer 1 or layer 2 mobility procedure to the candidate cell is satisfied.

At block 1030, the method 1000 includes transmitting a PRACH message to the candidate cell to initiate the layer 1 or layer 2 mobility procedure. In some implementations, for example, the UE 104, the TX processor 368, or the controller/processor 359 may execute the mobility component 140 or the PRACH component 146 to transmit a PRACH message to the candidate cell to initiate the layer 1 or layer 2 mobility procedure. In some implementations, at sub-block 1032, the block 1030 may optionally include transmitting the PRACH message comprises transmitting the PRACH message based on the single SSB when the triggering signal indicates a single SSB for the PRACH message. In some implementations, at sub-block 1034, the block 1030 may optionally include transmitting the PRACH message comprises selecting one SSB of the multiple SSBs for the PRACH message when the triggering signal indicates multiple SSBs for the PRACH message. In some implementations, at sub-block 1036, the block 1030 may optionally include selecting a received SSB of the candidate cell for the PRACH message when the triggering signal does not indicate an SSB for the PRACH message. In some implementations (e.g., when the triggering signal is a MAC-CE), at sub-block 1038, the block 1030 may optionally include transmitting the PRACH message on a RACH occasion for the candidate cell that is at least a threshold time period after the MAC-CE or after an acknowledgment of the MAC-CE. Accordingly, the UE 104, the TX processor 368, or the controller/processor 359 executing the mobility component 140 or the PRACH component 146 may provide means for transmitting a PRACH message to the candidate cell to initiate the layer 1 or layer 2 mobility procedure.

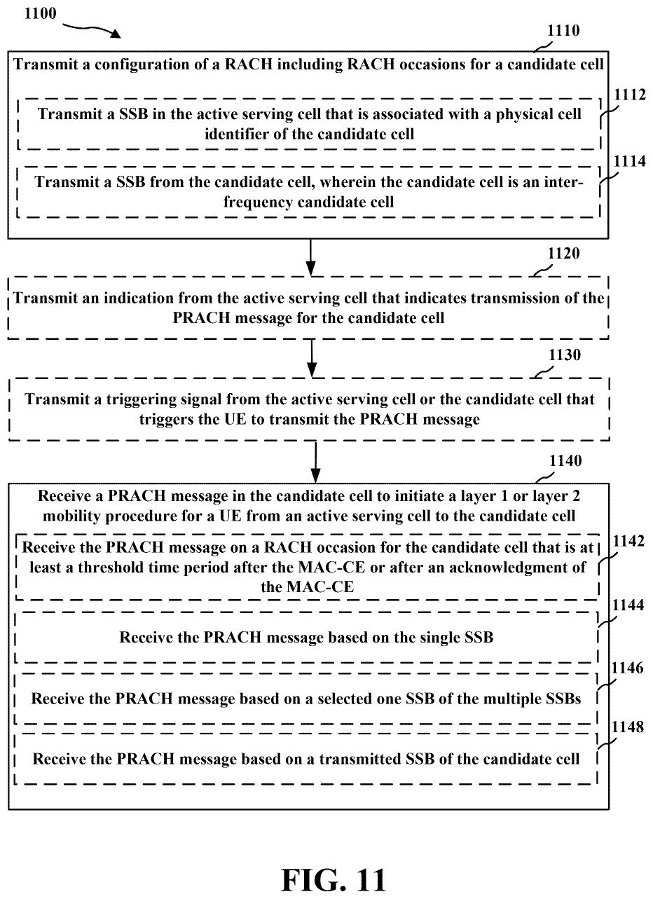

FIG. 11 is a flowchart of an example method 1100 for a network node to support a L1/L2 mobility procedure for a UE. The method 1100 may be performed by a network node (such as the base station 102, which may include the memory 376 and which may be the entire base station 102 or a component of the base station 102 such as the mobility control component 120, the TX processor 316, the RX processor 370, or the controller/processor 375). The method 1100 may be performed by the mobility control component 120 in communication with the mobility component 140 of the UE 104.

At block 1110, the method 1100 includes transmitting a configuration of a RACH including RACH occasions for a candidate cell. In some implementations, for example, the base station 102, the TX processor 316, or the controller/processor 375 may execute the mobility control component 120 or the configuration Tx component 122 to transmit a configuration of a RACH including RACH occasions for a candidate cell. In some implementations, at sub-block 1112, the block 1110 may optionally include transmitting a SSB in the active serving cell that is associated with a physical cell identifier of the candidate cell. The candidate cell may be an intra-frequency candidate cell 520d that has a same frequency, sub-carrier spacing, and bandwidth part as the active serving cell 510. In some implementations, at sub-block 1114, the block 1110 may optionally include transmitting a SSB 730 from the candidate cell, where the candidate cell is an inter-frequency candidate cell. The candidate cell 520 may be an inter-frequency candidate cell 520e. The inter-frequency candidate cell 520e may transmit the SSB 650 outside of a configured bandwidth 602 of an active serving cell 510. The inter-frequency candidate cell 520e may transmit the SSB 640 outside of an active bandwidth part 606 of an active serving cell 510 but within a configured bandwidth 602 of the active serving cell 510. The inter-frequency candidate cell 520e may transmit the SSB 630 within an active bandwidth part 606 of an active serving cell but with a center frequency or sub-carrier spacing that is different than an SSB 610 of the active serving cell 510. Accordingly, the base station 102, the TX processor 316, or the controller/processor 375 executing the mobility control component 120 or the configuration Tx component 122 may provide means for transmitting a configuration of a RACH including RACH occasions for a candidate cell.

At block 1120, the method 1100 may optionally include transmitting an indication from the active serving cell that indicates transmission of the PRACH message for the candidate cell. In some implementations, for example, base station 102, the TX processor 316, or the controller/processor 375 may execute the mobility control component 120 or the indication component 810 to transmit an indication from the active serving cell that indicates transmission of the PRACH message for the candidate cell. Accordingly, the base station 102, the TX processor 316, or the controller/processor 375 executing the mobility control component 120 or the indication component 810 may provide means for transmitting an indication from the active serving cell that indicates transmission of the PRACH message for the candidate cell.

At block 1130, the method 1100 may optionally include transmitting a triggering signal from the active serving cell that triggers the UE to transmit the PRACH message. In some implementations, for example, the base station 102, the RX processor 370, or the controller/processor 375 may execute the mobility control component 120 or trigger component 126 to transmit the triggering signal 760, 762 from the active serving cell 510 or the candidate cell 520 that triggers the UE 104 to transmit the PRACH message 770. For example, the triggering signal may be a DCI from the active serving cell 510 including a PDCCH order for the PRACH message 770 on the candidate cell 520. As another example, the triggering signal may be a DCI from the candidate cell including a PDCCH order for the PRACH message 770 on the candidate cell 520. As yet another example, the triggering signal may be MAC-CE transmitted by the active serving cell 510. As yet another example, the triggering signal may be a RRC configuration or reconfiguration of the candidate cell 520. In some implementations, the triggering signal indicates a single SSB, multiple SSBs, or no SSBs for the PRACH message 770. Accordingly, the base station 102, the RX processor 370, or the controller/processor 375 executing the mobility control component 120 or trigger component 126 may provide means for transmitting a triggering signal from the active serving cell that triggers the UE to transmit the PRACH message.

At block 1140, the method 1100 includes receiving a PRACH message in the candidate cell to initiate a layer 1 or layer 2 mobility procedure for a UE from an active serving cell to the candidate cell. In some implementations, for example, base station 102, the RX processor 370, or the controller/processor 375 may execute the mobility control component 120 or the PRACH Rx component 124 to receive a PRACH message in the candidate cell to initiate a layer 1 or layer 2 mobility procedure for a UE from an active serving cell to the candidate cell. In some implementations (e.g., where the triggering signal 760, 762 is a MAC-CE), at sub-block 1142, the block 1140 may optionally include receiving the PRACH message on a RACH occasion for the candidate cell that is at least a threshold time period after the MAC-CE or after an acknowledgment of the MAC-CE. In some implementations, at sub-block 1144, the block 1140 may optionally include receiving the PRACH message based on the single SSB. In some implementations, at sub-block 1146, the block 1140 may optionally include receiving the PRACH message based on a selected one SSB of the multiple SSBs. In some implementations, at block 1148, the block 1140 may optionally include receiving the PRACH message based on a transmitted SSB of the candidate cell. Accordingly, the base station 102, the RX processor 370, or the controller/processor 375 executing the mobility control component 120 or the PRACH Rx component 124 may provide means for receiving a PRACH message in the candidate cell to initiate a layer 1 or layer 2 mobility procedure for a UE from an active serving cell to the candidate cell.

The following numbered clauses provide an overview of aspects of the present disclosure:

Aspect 1: A method of wireless communication at a user equipment (UE), comprising: receiving a configuration of a random access channel (RACH) including RACH occasions for a candidate cell; determining that a condition for a layer 1 or layer 2 mobility procedure to the candidate cell is satisfied; and transmitting a physical RACH (PRACH) message to the candidate cell to initiate the layer 1 or layer 2 mobility procedure.

Aspect 2: The method of Aspect 1, wherein receiving the configuration of the RACH comprises receiving a synchronization signal block (SSB) that is transmitted by an active serving cell and that is associated with a physical cell identifier of the candidate cell.

Aspect 3: The method of Aspect 2, wherein the candidate cell has a same frequency, sub-carrier spacing, and bandwidth part as the active serving cell.

Aspect 4: The method of Aspect 1, wherein receiving the configuration of the RACH comprises receiving a SSB that is transmitted by the candidate cell, wherein the candidate cell is an inter-frequency candidate cell.

Aspect 5: The method of Aspect 4, wherein the inter-frequency candidate cell transmits the SSB outside of an active bandwidth part of an active serving cell but within a configured bandwidth of the active serving cell.

Aspect 6: The method of Aspect 4, wherein the inter-frequency candidate cell transmits the SSB outside of a configured bandwidth of an active serving cell.

Aspect 7: The method of Aspect 4, wherein the inter-frequency candidate cell transmits the SSB within an active bandwidth part of an active serving cell but with a center frequency or sub-carrier spacing that is different than an SSB of the active serving cell.

Aspect 8: The method of any of Aspects 1-7, wherein determining that a condition for a layer 1 or layer 2 mobility procedure to the candidate cell is satisfied comprises receiving an indication from an active serving cell that indicates transmission of the PRACH message for the candidate cell.

Aspect 9: The method of any of Aspects 1-8, wherein determining that a condition for a layer 1 or layer 2 mobility procedure to the candidate cell is satisfied comprises evaluating a rule to select the candidate cell.

Aspect 10: The method of Aspect 9, wherein the rule indicates the candidate cell when a cell-level or beam-level measurement for the candidate cell is greater than a threshold for the candidate cell.

Aspect 11: The method of Aspect 9, wherein the rule indicates the candidate cell when a cell-level or beam-level measurement for the candidate cell has changed by at least a threshold amount for the candidate cell.

Aspect 12: The method of any of Aspects 1-8, wherein determining that the condition for the layer 1 or layer 2 mobility procedure to the candidate cell is satisfied comprises determining that a timing advance misalignment timer has expired for the candidate cell.

Aspect 13: The method of any of Aspects 1-8, wherein determining that a condition for a layer 1 or layer 2 mobility procedure to the candidate cell is satisfied comprises receiving a triggering signal from an active serving cell or the candidate cell that triggers transmitting the PRACH message.

Aspect 14: The method of Aspect 13, wherein the triggering signal is a downlink control information (DCI) from the active serving cell including a physical downlink control channel (PDCCH) order for the PRACH message on the candidate cell.

Aspect 15: The method of Aspect 13, wherein the triggering signal is a downlink control information (DCI) from the candidate cell including a physical downlink control channel (PDCCH) order for the PRACH message on the candidate cell.

Aspect 16: The method of Aspect 13, wherein the triggering signal is a media access control (MAC) control element (CE) transmitted by the active serving cell, wherein transmitting the PRACH message comprises transmitting the PRACH message on a RACH occasion for the candidate cell that is at least a threshold time period after the MAC-CE or after an acknowledgment of the MAC-CE.

Aspect 17: The method of Aspect 13, wherein the triggering signal is a radio resource control (RRC) configuration or reconfiguration of the candidate cell.

Aspect 18: The method of any of Aspects 13-17, wherein the triggering signal indicates a single SSB for the PRACH message, wherein transmitting the PRACH message comprises transmitting the PRACH message based on the single SSB.

Aspect 19: The method of any of Aspects 13-17, wherein the triggering signal indicates multiple SSBs for the PRACH message, wherein transmitting the PRACH message comprises selecting one SSB of the multiple SSBs for the PRACH message.

Aspect 20: The method of any of Aspects 13-17, wherein the triggering signal does not indicate an SSB for the PRACH message, wherein transmitting the PRACH message comprises selecting a received SSB of the candidate cell for the PRACH message.

Aspect 21: A method of wireless communication at network, comprising: transmitting a configuration of a random access channel (RACH) including RACH occasions for a candidate cell; and receiving a physical RACH (PRACH) message in the candidate cell to initiate a layer 1 or layer 2 mobility procedure for a user equipment (UE) from an active serving cell to the candidate cell.

Aspect 22: The method of Aspect 21, wherein transmitting the configuration of the RACH comprises transmitting a synchronization signal block (SSB) in the active serving cell that is associated with a physical cell identifier of the candidate cell.

Aspect 23: The method of Aspect 22, wherein the candidate cell has a same frequency, sub-carrier spacing, and bandwidth part as the active serving cell.

Aspect 24: The method of Aspect 21, wherein transmitting the configuration of the RACH comprises transmitting a SSB from the candidate cell, wherein the candidate cell is an inter-frequency candidate cell.

Aspect 25: The method of Aspect 24, wherein the inter-frequency candidate cell transmits the SSB outside of an active bandwidth part of the active serving cell but within a configured bandwidth of the active serving cell.

Aspect 26: The method of Aspect 24, wherein the inter-frequency candidate cell transmits the SSB outside of a configured bandwidth of the active serving cell.

Aspect 27: The method of Aspect 24, wherein the inter-frequency candidate cell transmits the SSB within an active bandwidth part of the active serving cell but with a center frequency or sub-carrier spacing that is different than an SSB of the active serving cell.

Aspect 28: The method of any of Aspects 21-27, further comprising transmitting an indication from the active serving cell that indicates transmission of the PRACH message for the candidate cell.

Aspect 29: The method of any of Aspects 21-28, further comprising transmitting a triggering signal from the active serving cell that triggers the UE to transmit the PRACH message.

Aspect 30: The method of Aspect 29, wherein the triggering signal is a downlink control information (DCI) from the active serving cell including a physical downlink control channel (PDCCH) order for the PRACH on the candidate cell.

Aspect 31: The method of Aspect 29, wherein the triggering signal is a downlink control information (DCI) from the candidate cell including a physical downlink control channel (PDCCH) order for the PRACH message on the candidate cell.

Aspect 32: The method of Aspect 29, wherein the triggering signal is a media access control (MAC) control element (CE) transmitted by the active serving cell, wherein receiving the PRACH message comprises receiving the PRACH message on a RACH occasion for the candidate cell that is at least a threshold time period after the MAC-CE or after an acknowledgment of the MAC-CE.

Aspect 33: The method of Aspect 29, wherein the triggering signal is a radio resource control (RRC) configuration or reconfiguration of the candidate cell.

Aspect 34: The method of any of Aspects 29-33, wherein the triggering signal indicates a single SSB for the PRACH message, wherein receiving the PRACH message comprises receiving the PRACH message based on the single SSB.

Aspect 35: The method of any of Aspects 29-33, wherein the triggering signal indicates multiple SSBs for the PRACH message, wherein receiving the PRACH message comprises receiving the PRACH message based on a selected one SSB of the multiple SSBs.

Aspect 36: The method of any of Aspects 29-33, wherein the triggering signal does not indicate an SSB for the PRACH message, wherein receiving the PRACH message comprises receiving the PRACH message based on a transmitted SSB of the candidate cell.

Aspect 37: An apparatus for wireless communication, comprising: a transceiver; a memory storing computer-executable instructions; and a processor coupled with the transceiver and the memory and configured to: execute the computer-executable instructions to execute the instructions to perform the method of any of Aspects 1-20.

Aspect 38: An apparatus for wireless communication, comprising: a transceiver; a memory storing computer-executable instructions; and a processor coupled with the transceiver and the memory and configured to execute the computer-executable instructions to perform the method of any of Aspects 21-36.

Aspect 39: An apparatus for wireless communication, comprising the method of any of Aspects 1-20.

Aspect 40: An apparatus for wireless communication, comprising means for performing the method of any of Aspects 21-36.

Aspect 41: A non-transitory computer-readable medium storing computer-executable instructions that when executed by a processor of a user equipment (UE) cause the UE to perform the method of any of Aspects 1-20.

Aspect 42: A non-transitory computer-readable medium storing computer-executable instructions that when executed by a processor of a network node cause the network node to perform the method of any of Aspects 21-36.

As used herein, a phrase referring to “at least one of” a list of items refers to any combination of those items, including single members. As an example, “at least one of: a, b, or c”is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. An apparatus for wireless communication at a user equipment (UE), comprising:
a transceiver;
a memory storing computer-executable instructions; and
a processor coupled with the transceiver and the memory and configured to execute the computer-executable instructions to:
receive, via the transceiver, a configuration of a random access channel (RACH) including RACH occasions for a candidate cell;
determine that a condition for a layer 1 or layer 2 mobility procedure to the candidate cell is satisfied; and
transmit, via the transceiver, a physical RACH (PRACH) message to the candidate cell to initiate the layer 1 or layer 2 mobility procedure.

2. The apparatus of claim 1, wherein the configuration of the RACH is a synchronization signal block (SSB) that is transmitted by an active serving cell and that is associated with a physical cell identifier of the candidate cell.

3. The apparatus of claim 2, wherein the candidate cell has a same frequency, sub-carrier spacing, and bandwidth part as the active serving cell.

4. The apparatus of claim 1, wherein the configuration of the RACH is a SSB that is transmitted by the candidate cell, wherein the candidate cell is an inter-frequency candidate cell.

5. The apparatus of claim 4, wherein the inter-frequency candidate cell transmits the SSB outside of an active bandwidth part of an active serving cell but within a configured bandwidth of the active serving cell.

6. The apparatus of claim 4, wherein the inter-frequency candidate cell transmits the SSB outside of a configured bandwidth of an active serving cell.

7. The apparatus of claim 4, wherein the inter-frequency candidate cell transmits the SSB within an active bandwidth part of an active serving cell but with a center frequency or sub-carrier spacing that is different than an SSB of the active serving cell.

8. The apparatus of claim 1, wherein to determine that a condition for a layer 1 or layer 2 mobility procedure to the candidate cell is satisfied, the processor is configured to receive an indication from an active serving cell that indicates transmission of the PRACH message for the candidate cell.

9. The apparatus of claim 1, wherein to determine that a condition for a layer 1 or layer 2 mobility procedure to the candidate cell is satisfied, the processor is configured to evaluate a rule to select the candidate cell, and wherein the rule indicates the candidate cell when a cell-level or beam-level measurement for the candidate cell is greater than a threshold for the candidate cell or has changed by at least a threshold amount for the candidate cell.

10. (canceled)

11. (canceled)

12. The apparatus of claim 1, wherein to determine that a condition for a layer 1 or layer 2 mobility procedure to the candidate cell is satisfied, the processor is configured to determine that a timing advance misalignment timer has expired for the candidate cell.

13. The apparatus of claim 1, wherein to determine that a condition for a layer 1 or layer 2 mobility procedure to the candidate cell is satisfied, the processor is configured to receive a triggering signal from an active serving cell or the candidate cell that triggers transmitting the PRACH message.

14. The apparatus of claim 13, wherein the triggering signal is a downlink control information (DCI) from the active serving cell including a physical downlink control channel (PDCCH) order for the PRACH message on the candidate cell.

15. The apparatus of claim 13, wherein the triggering signal is a downlink control information (DCI) from the candidate cell including a physical downlink control channel (PDCCH) order for the PRACH message on the candidate cell.

16. The apparatus of claim 13, wherein the triggering signal is a media access control (MAC) control element (CE) transmitted by the active serving cell, wherein transmitting the PRACH message comprises transmitting the PRACH message on a RACH occasion for the candidate cell that is at least a threshold time period after the MAC-CE or after an acknowledgment of the MAC-CE.

17. The apparatus of claim 13, wherein the triggering signal is a radio resource control (RRC) configuration or reconfiguration of the candidate cell.

18. The apparatus of claim 13, wherein the triggering signal indicates a single SSB for the PRACH message, wherein the processor is configured to transmit the PRACH message based on the single SSB.

19. The apparatus of claim 13, wherein the triggering signal indicates multiple SSBs for the PRACH message, wherein the processor is configured to select one SSB of the multiple SSBs for the PRACH message.

20. (canceled)

21. An apparatus for wireless communication at a network node, comprising:
a transceiver;
a memory storing computer-executable instructions; and
a processor coupled with the transceiver and the memory and configured to execute the computer-executable instructions to:
transmit a configuration of a random access channel (RACH) including RACH occasions for a candidate cell; and
receive a physical RACH (PRACH) message in the candidate cell to initiate a layer 1 or layer 2 mobility procedure for a user equipment (UE) from an active serving cell to the candidate cell.

22. (canceled)

23. (canceled)

24. (canceled)

25. The apparatus of claim 21, wherein the processor is configured to transmit a triggering signal from the active serving cell that triggers the UE to transmit the PRACH message, wherein the triggering signal is a downlink control information (DCI) from the active serving cell including a physical downlink control channel (PDCCH) order for the PRACH on the candidate cell.

26. (canceled)

27. A method of wireless communication at a user equipment (UE), comprising:
receiving a configuration of a random access channel (RACH) including RACH occasions for a candidate cell;
determining that a condition for a layer 1 or layer 2 mobility procedure to the candidate cell is satisfied; and
transmitting a physical RACH (PRACH) message to the candidate cell to initiate the layer or layer 2 mobility procedure.

28. (canceled)

29. (canceled)

30. (canceled)
